(19) United States
(12) Patent Application Publication
(10) Pub. No.: US 2008/0053246 A1
(43) Pub. Date: Mar. 6, 2008

(54) Reduction torque formula from a fuel burning system to an electrical system

(76) Inventor: Westley E Elkin, Palmetto, FL (US)

Correspondence Address: Westley E Elkin, 1612 19th Ave. W., Palmetto, FL, 34221, US

(21) Appl. No.: 11/514,406

(22) Filed: Sep. 1, 2006

(51) Int. Cl. G01L 5/24

(52) U.S. Cl. 73/862.28

(57) ABSTRACT

To do work a power device needs to supply a given supply of torque, and until this measure of torque is supplied the desired performance will not be met. In a gasoline engine the desired torque/horsepower is compensated with higher factors due to the inefficiencies of that system to reach the desired torque until peaking at an expressed rpm. However, the electric motor reaches the desired torque at a greatly reduced rpm, and continues supplying that torque at any rpm above that base rpm. The combination of batteries, electric motors, controllers, connectors, gearing, and generators as system devices along with the use of the following facts, and formula, a ratio of interpretative algorithms can be obtained to procure the resultant outcomes. 1.) One of the individual torque components of an electric motor is BREAKDOWN TORQUE, which is described as “The maximum torque a motor will develop at rated voltage without a relatively abrupt drop or loss in speed.” 2.) The gasoline engine BREAKDOWN TORQUE is reached at X rpm's, which are supplied by the manufacturer that has tested their product with a dynamo. Ft.lb. Gasoline engine torque=gt Electric motor horsepower=EH electric factor-EF=1.12934 sqrt(gt)*CEF=EH The common, but not exclusive use for this system is to extend the range of an electrical system that does not draw its source of power from a stationary point such as a city power company. This formula and device can be modified to be the sole power source for residential as well as commercial applications. A typical application installed in a moving vehicle could follow the following diagram. A battery bank supplies power to an electric motor (M1), which supplies torque to a generator (G1) that supplies power to another electric motor (M2), which supplies power to another generator (G2) that supplies power to an electric motor (M3), and a battery charger that supplies charging power for the battery bank, and power to run the first electric motor. The (M3) motor then supplies the power to move the vehicle.

### FIELD OF THE INVENTION

This invention relates to a formula for determining the horsepower/torque replacement sizing between fuel-burning engines, and electric motors.

### DESCRIPTION OF THE RELATED ART

Electric portable power systems have been designed and executed in many ways, and for numerous purposes. Whether it is powered through natural resources such as wind, water, solar, disposable fuel, etc., or by non-replenishing resources such as gasoline, steam, coal, diesel, etc. For example, most dwellings are connected to a public utility that supplies needed power to run the electrical devices in the dwelling. Likewise transportation systems such as trains, busses, flying machines, two wheeled vehicles, and automobiles obtain their source from a portable device such as an engine, or in some cases an electrical device. All of these instances are powered through portable power systems. Generators can power electrical needs, and fuel can supply generation for engines.

In view of these various types of portable power systems, the individual devices, be it a hybrid vehicle, or gasoline/diesel powered generator, or solar fulfillment, still offer only a limited use application limited by fuel, or battery discharge, or limited input in lieu of solar applications. If an unlimited supply of fuel is available, and the expense in not a problem, then an improvement to alleviate fuel burning is of no consequence to this invention. If a solar bank can be assembled to supply the necessary solar power to an application, then this invention is not necessary. If range is not a problem for the total electric vehicles, which only average at this date to somewhere between 40-120 miles, then this invention is not necessary, but if any of these restrictions are not acceptable, then it constitutes an inefficiency that this invention can resolve.

### SUMMARY OF THE INVENTION

The present invention concerns a method to extend the range of a complete electrically powered system, and conserve fossil fuels. The method can include multiple reductions to evade large rechargeable battery packs. This method can include the steps of coupling a battery pack to the first electric motor in the reduction chain, coupling the first electric motor to the first generator, which in turn can be used for powering a device, and include a charging device to be coupled with it to supply regenerative power to the battery pack. With this arrangement the depleted power of the battery pack can be either partially regained, or fully regained dependent on the level of the reduction theory.

Also, the reduction formula can be effectively used to supply all of the depleted battery power if sufficient reductions are taken.

As an example, the battery pack can be coupled to the first electric motor in the reduction chain. Then coupling the first electric motor to the first generator, which in turn can be used for a charging device to be coupled with it to supply regenerative power to the battery pack, but not so much as to deplete the necessary power to run the second electric motor. The second electric motor then will be used to supply the second generator, which will be used to power sufficient charging systems that will replenish all or most of the power drained from the battery bank, supply power to run the first electric motor through the charging system, and finally supply the necessary amount of power to run the third motor which will supply power for the powered system. An example would be, but not limited to, an electrical vehicle.

As an example, the battery pack can be coupled to the first electric motor in the reduction chain. Then coupling the first electric motor to the first generator, which in turn can be used for a charging device to be coupled with it to supply regenerative power to the battery pack, but not so much as to deplete the necessary power to run the second electric motor. The second electric motor then will be used to supply the second generator, which will be used to power sufficient charging systems that will replenish all or most of the power drained from the battery bank, supply power to run the first electric motor through the charging system, and finally supply the necessary amount of power to run the powered system. An example would be, but not limited to, a power supply for a residential, or commercial building.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a system for creating a power supply for an electric vehicle in accordance with an embodiment of the inventive arrangements;

FIG. 2 illustrates an example of a system for creating a power supply for a stationary power supply in accordance with an embodiment of the inventive arrangements;

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

This invention involves a method and system for producing enough power to displace the discharge of the battery bank. A series of electric motors DC/AC, and generators that are chosen via the formula:

Ft. LB. Gasoline engine torque=gt

Electric motor horsepower=EH

electric factor-EF=1.12934

sqrt(gt)*EF=EH

Which scales the proper electrical horsepower/torque to replace the gasoline/diesel, fuel burning generator motor.

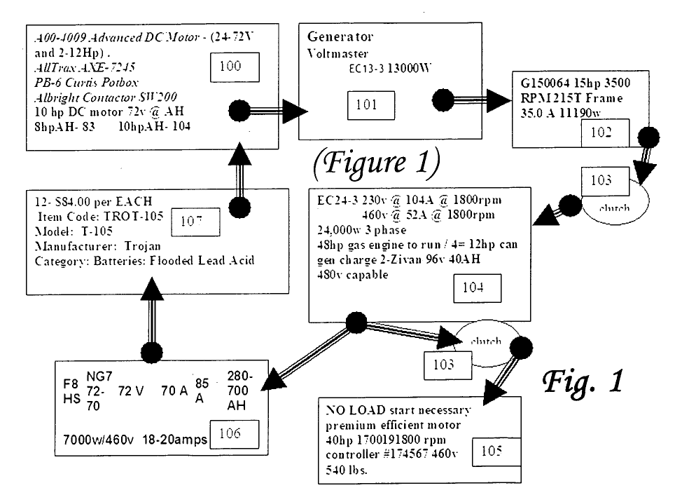

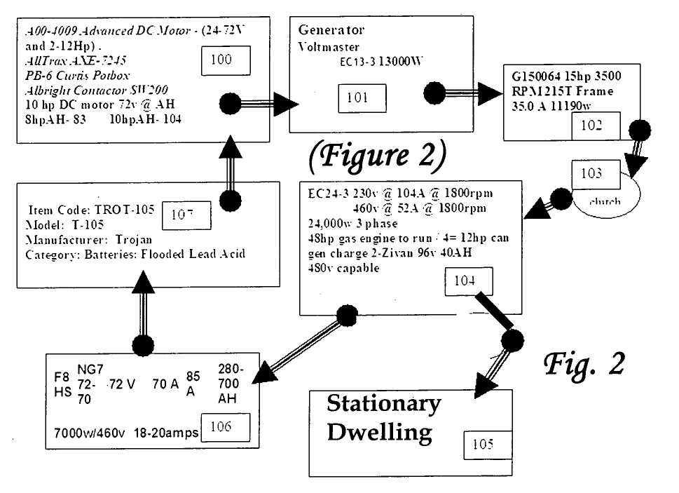

Referring to FIG. 1, a system 107 that can run a DC motor, and be charged at the same or close to the same rate of discharge from system 106. The system 107 can also supply the necessary voltage to run the 100 system. System 100 supplies the necessary power via a mechanical device not limited to either a transmission, or belt drive, but a drive system connecting the two together; system 100, and 101. System 101 produces enough voltage to run system 102 at the proper rating. In turn system 102 produces power that is transmitted through system 103 to enable system 102 to get to full power before engaging system 104. This clutch, or transmission fixture 103 is not limited to these choices. After engaging system 104, and system 104 is powered up, system 106 is engaged to enable power to be transmitted back into the complete system, which will charge the battery bank, and run the system 100 motor. System 105 then can be excited by power supplied through system 104, which can power a portable device. If the system in FIG. 2 is desired, the system 105 is eliminated, and power can be extracted from system 104.

Referring to FIG. 1, and FIG. 2, this invention makes use of electric motors that replace fuel-burning engines on the generators that power the electric motors. This invention is intended to supply an alternative power source for application independent of disposable fuel either through for example fossil fuel, or fossil fuel derived from public utilities. This invention is based on the algorithm, which calculates the replacement of said fuel-burning generator engines; thus making it possible to build said system without the restraint of previous limitations. Until this algorithm was discovered there was no known calculation, or configuration available.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A process, which uses reduction algorithms, to define connected horsepower/torque ratings of both fossil fuel/disposable fuel engines, and electric motors. The formula for this process calculates the comparison horsepower ratings between fuel-powered engines, and electric motors via torque to supply accurate sizing. This formula will give in horsepower ratings the electric motor horsepower rating that will replace a fuel-burning engine.

2. A process, which uses reduction algorithms, to define connected horsepower/torque ratings of both fossil fuel/disposable fuel engines, generators, and electric motors. Using these systems along with electronic connectors, contactors, switches, and battery packs, but not limited to these, to assemble a propulsion system that can supply a system with power at a higher return for input than current battery to motor systems, and by using no fossil fuel burning devices. This system type is diagramed in FIG. 1, and FIG. 2, but not limited to these systems. The claim is to make a system with a combination of the devices, in this claim, for the expressed purpose of energizing a system to produce power for stationary, and motion devices.

3. The process as defined in claim 1, wherein: the use of the following formula will give the proper horsepower rating to replace a fuel-burning engine with an electric motor that can be used for propulsion:
Ft. LB. Gasoline engine torque=gt
Electric motor horsepower=EH
electric factor-EF =1.12934
sqrt(gt) * EF=EH

4. The process as defined in claim 1, wherein: the reduction of fuel-burning engine horsepower can be discovered, so a sufficient electrical motor can replace the work of said fuel-powered engine, and provide a continuous torque rather that variable torque that is present in the fuel-burning engine.

5. The process as defined in claim 1, wherein: using the formula to give the correct horsepower rating of the electric motors which replace the fuel-burning engines that drive generators, and in some applications make use of a battery bank, electric motors, generators, controllers, contactors, and battery chargers, which are assembled in such a way that the depletion of the battery bank will be reduced substantially if not completely. Note. hybrid, or electric vehicles either have a fuel-burning engine in conjunction with an electric motor apparatus, or they have a depleting battery bank that has neither long range, nor a sufficient charging system to replace the depleted charge.

6. The process as defined in claim 4, wherein: the battery bank supplies power to the first electric motor, which has replaced the fuel-burning engine for the first generator, which in turn supplies the power to run the second electric motor, which has replaced the fuel-burning engine for the second generator.

7. The process as defined in claim 4, wherein: the reduction formula (in claim 2) can be extended to include multiple combinations of these systems for the expressed purpose of reducing the depletion of the battery bank.

8. The process as defined in claim 4, wherein: the reduction formula can be extended to include multiple combinations of these systems for the expressed purpose of reducing the depletion of the battery bank, and replace the need for a large battery bank to acquire range for a vehicle, or power system.

9. The method according to claim 1, wherein the system is coupled to a transportation vehicle for propulsion purposes.

10. The method according to claim 8, wherein the system is at least one of a automotive transportation vehicle, a two wheeled propulsion vehicle, a flying vehicle.

11. The method according to claim 1, wherein the system is coupled to a stationary or temporary dwelling.

12. The method according to claim 10, wherein the system is at least one of a power supply for a residential dwelling, commercial dwelling, or outbuildings of any kind that uses a power system.
